(19) United States
(12) Patent Application Publication
(10) Pub. No.: US 2004/0139731 A1
(43) Pub. Date: Jul. 22, 2004

(54) Structure of fuel complete combustion acceleration for automotive vehicles

(76) Inventor: Ching-Chi Chiu, Feng-Yuan (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/347,879

(22) Filed: Jan. 22, 2003

(51) Int. Cl. F01N 3/00; F02M 27/00

(52) U.S. Cl. 60/275; 123/538; 123/539

(57) ABSTRACT

The present invention relates generally to “The structure of fuel complete Combustion Acceleration for Automotive Vehicles” which contains a rubber vesicant and led metal sheet (or led type metal sheet), which the rubber vesicant is formed by mixing and allotting with proper ration of rubber and metal oxide material which contains far infrared ray. Therefore, the rubber vesicant has function of electromagnetic wave with far infrared ray. When the rubber vesicant is wrapped up with the outer part of the tube which supplies oil and air in a automotive vehicle, it can catalyze the oil and air molecule passing through the tube to a rearrangement in order by the heating arising from the engine, meanwhile it will dash against the molecule into tiny ones so as to promote the gas to burn thoroughly. Besides, the led metal sheet (or led type metal sheet) is wrapped with the outer part of the rubber vesicant, which is used not only to fix the rubber vesicant, but to cover, separate and decrease the electromagnetic wave of far infrared ray from releasing outward so as to enhance its heat conducting and warm keeping, which can shorten the conducting time of the vesicant and promote its efficiency.

### SUMMARY OF THE INVENTION

The present invention relates generally to “The Structure of Fuel Complete Combustion Acceleration for Automotive Vehicles”, which contains a rubber vesicant and led metal sheet (or lead type metal sheet), which the rubber vesicant is formed by mixing and allotting with proper ration of rubber and metal oxide material which contains far infrared ray. Therefore, the rubber vesicant has function of electromagnetic wave with far infrared ray. When the rubber vesicant is wrapped up with the outer part of the tube which supplies oil and air in a automotive vehicle, it can catalyze the oil and air molecule passing through the tube to a rearrangement in order by the heating arising from the engine, meanwhile it will dash against the molecule into tiny ones so as to promote the gas to burn thoroughly. Besides, the led metal sheet (or led type metal sheet) is wrapped with the outer part of the rubber vesicant, which is used not only to fix the rubber vesicant, but to cover, separate and decrease the electromagnetic wave of far infrared ray from releasing outward so as to enhance its heat conducting and warm keeping, which can shorten the conducting time of the vesicant and promote its efficiency.

(1) Drawing: FIG. 3

(2) Brief Description of the Drawings

rubber vesicant: 10

valve: 11

led metal sheet (or led type metal sheet) 20

intake pipe: 32

### DESCRIPTION OF THE INVENTION

[Technical Field of Prior Art]

The present invention relates generally to “The Structure of Fuel Complete Combustion Acceleration for Automotive Vehicles”, especially focuses on an object structure which can be used in automobiles or motorcycles to promote a thorough burning of fuel.

[Previous Technique]

According to people's experiences and test reports, it is cognoscible that when the engine of the automotive vehicles starts and burns, if the fuels do not burn thoroughly, the engine will not only increase exhausting CO and HC which will pollute the air, but will also cause problems such as gas burning, carbon accumulation and inadequate power. Besides general reasons of incomplete fuels burning such as engine's broke-down, dusty air cleaner, old spark-plugs and nozzles' carbon accumulation, in fact, there is another major reason. That is, during the process of fuel burning, on account that the structure of gas molecule is larger and in disorder, besides, it has worse density when combining with air. As shown on FIG. 1, the arrangement of general gas molecule presents status of unstable pitch, even in disorder and the air molecule presents the same. Therefore, when gas molecule combine with air molecule, its contact surface square will be limited due to disorder arrangement (less contact surface square), which leads to the result of incomplete burning and causes problems of air pollution, engine's much gas burning, carbon accumulation and inadequate power.

Furthermore, now there are many kinds of products which have claimed “saving gas and speeding up”. Their structure, way of using and functions are varied. However, in addition to those products have defects of higher cost, not easy to be installed and easy broken (some of them are controlled by precise electronic), they can only be used in automobiles, not in motorcycles. There are more motorcycles than automobiles in Taiwan. It is true that the riders of motorcycles also need to improve their motorcycles so as to save gas and get more speed.

In consideration of the problems mentioned above, with the inventor's many year experiences in sales and the research and development about structures of parts for automobiles and motorcycles and the spirit of developing and creating, the inventor has studied diligently with a quiet mind. After testing and improving for many times, the inventor has finally succeeded in creating the present invention.

[Content of Prior Art]

Therefore, the main objective of the present invention is to provide a structure to achieve the purpose of fuel complete combustion for automobiles and motorcycles by ways of wrapping up in a simple structure and convenient usage.

In order to achieve the above objective, the present invention “The Structure of Fuel Complete Combustion Acceleration for Automotive Vehicles” is mainly to wrap up a rubber vesicant which contains far infrared ray material on the outer part of fuel pipe, intake pipe and exhaust gas circling pipe of an automobile so that the rubber vesicant can generate an electromagnetic wave of the far infrared ray. With the function of the electromagnetic wave of the far infrared ray, structure of the air molecule and gas molecule passing through the three pipes can be rearranged in order and become microscopic so as to increase the contact surface square while combined and to achieve the purpose of promoting gas complete combustion.

The above are only a brief description of the features of the present invention, in order to make the examine committee and the professionals who are reading this better understand the technical means of the present invention as well as to practice according to the content of the present inventions. Therefore, it will be stated in coordination with drawings. Nevertheless, the following descriptions are only to explain the better practical example, not to make any limitation of the present invention. Therefore, any modification or amendment of the present invention under a similar spirit of inventions shall be concluded within the protection range of the present invention.

[Way of Practice]

As shown in FIG. 2˜6, the present invention “The Structure of Fuel Complete Combustion Acceleration for Automotive Vehicles” contains one rubber vesicant 10 and at least led metal sheet (or led type metal sheet) 20, the rubber vesicant 10 is wrapped up on the outer parts of fuel pipe 31, intake pipe 32 and exhaust gas circling pipe 33 and the led metal sheet (or led type metal sheet) 20 covers on the outer layer of the rubber vesicant 10, in which

The rubber vesicant 10 which can be made into shape of sheet or cylinder is formed by mixing and allotting with proper ration of rubber and metal oxide material which contains far infrared ray so that the rubber vesicant 10 has function of electromagnetic wave with far infrared ray. The rubber vesicant 10 is in cylinder shape and in an open structure of non-sealing. With the function of electromagnetic wave radioactivity arising from the far infrared ray, the molecule structure of the gas and air molecule around the rubber vesicant can be microscopic and rearranged.

The led metal sheet (or led type metal sheet) 20 is a twisted metal, heat conductible, fast heat absorbing. Covered in curve on the outer part of the rubber vesicant 10 with single or multiple sheets in bamboo shape. The led type metal sheet 20 can not only fix the rubber vesicant layer 10, but also come to the results of covering and isolating and decreasing the energy of electromagnetic wave of far infrared ray spreading outward and focusing the energy within the rubber vesicant 10, which helps to speed up the heat conducting and warm keeping.

With the above component, when the rubber vesicant 10 is wrapped up on outer part of the fuel pipe 31, intake pipe 32 and exhaust gas circling pipe 33, it will enable to rearrange the molecule structure of the gas and air passing through the three pipes in order. As shown in FIG. 7, the gas molecules are gathering and connecting with each other irregularly and disorderly. After being effected by the far infrared ray of the rubber vesicant 10, they all convert into tiny molecules in regular order, which can be better seen from FIG. 8. Therefore, when the gas molecules combine and burn with air molecules, both the contact surface square increases and leads to the results of gas thorough combustion, which can gain the functions of saving gas, increasing power, decreasing carbon accumulation and exhaust gas.

Furthermore, the reason why the present invention adopts vesicant is as follows. After allotting the metal oxide containing far infrared ray, they are ground into powders as tiny as nano-scale. On the process of making by combing the tiny powders and other materials, it will arise a condition of agglutinating. So by way of spreading the tiny powders in vesicant forming, they can be equally spread into the surface of the tiny apertures, which present a round space so as to activate the electromagnetic wave of the far infrared ray. Furthermore, the original specific weight of the rubber is 1.35. After vesicant forming, it changes into an unreal specific weight 0.3˜0.5, which is regarded the best requirement for apertures, called “a vacant space”. With this “vacant space”, the radial direction angles of the electromagnetic wave can be equally spread out in all directions.

Moreover, the best temperature for releasing of the far infrared ray has to be between 60-70° C. As shown in FIG. 9, since the invention can be wrapped up on the outer part of the fuel pipe 31, intake pipe 32 and exhaust gas circling pipe 33 in the automobile engine, while the automobile is running, with the high heat generated from the engine 41 being absorbed through the led metal sheet (or led type metal sheet) 20 and conducted to the rubber vesicant 10, which has the best temperature to release the electromagnetic wave, the rubber vesicant 10 of the invention can then release the electromagnetic wave of the far infrared ray so as to achieve the function of fuel complete combustion.

Besides, because the rubber itself has functions of heat resistant and warm keeping and steady warm keeping inner side the vesicant rubber after being formed. Therefore, the forming by mixing with far infrared ray material, the rubber vesicant can help releasing the electromagnetic wave of the far infrared ray. Moreover, the outer part of the rubber vesicant 10 can be wrapped up with a led metal sheet (or led type metal sheet) 20. The led metal sheet (or led type metal sheet) 20 has double functions: “One of them is to cover and prevent the electromagnetic wave from leaking”, and “The other is to speed up the heat conducting”. That is, the led metal sheet (or led type metal sheet) 20 can decrease the outward releasing of the electromagnetic wave of the far infrared ray and further speed up the complete releasing of the electromagnetic wave of the far infrared ray. For example, if a thickness of 8 m/m of vesicant is used, its outer layer contacts the led metal sheet and will soon absorb the temperature of the engine and release wave energy, while the temperature of the inner part will be kept in a best temperature (60-70° C.) for releasing wave energy because the vesicant has effects of warm keeping and delaying a sudden rising up temperature, which can increase and double the life of wave energy of the rubber vesicant 10 or more. According to the above statements, the features of the present invention are “Be easily used by wrapping”, “There are gap spaces in the vesicant which can multiply enlarge the energy wave of the far infrared ray”, “The inner part can gain the best temperature of wave energy releasing which can increase and double the lifelong usage of wave energy of the products or more.”

Finally, it is claimed that the present invention relates to a wrapped object of a metal oxide material which contains the far infrared ray, covered on the fuel pipe 31, intake pipe 32 and exhaust gas circling pipe of automobiles. Therefore, any wrapped objective objects of a metal oxide material which contains the far infrared ray belong to the applicable range of the present invention. Moreover, if the outer part of the above mentioned wrapped objectives are added a led metal sheet (or led type metal sheet) 20 belong to the related applications of the present invention.

In order to prove the products of the present invention does have its expected effects, the inventor has made a special route test including on the free way and high way and the test result is very inspiring. The gas is saved at least 10-20% or above in an automobile (in a motorcycle 25-35%).

In conclusion, the present invention “The Structure of Fuel Complete Combustion Acceleration for Automotive Vehicles” is indeed a design with both practical and progressive features which totally conform to the important conditions of patent application. Herein apply for and hope it will be examined and approved soon.

### BRIEF DESCRIPTION OF THE DRAWINGS

FIG. 1: shows a schematic view of air and gas molecule before being rearranged in order.

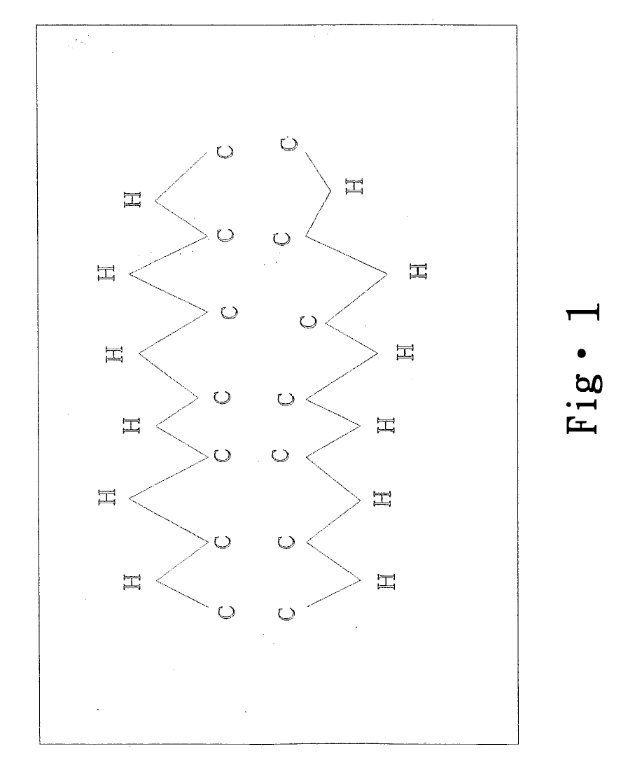

FIG. 2: shows a combined schematic view of the present invention.

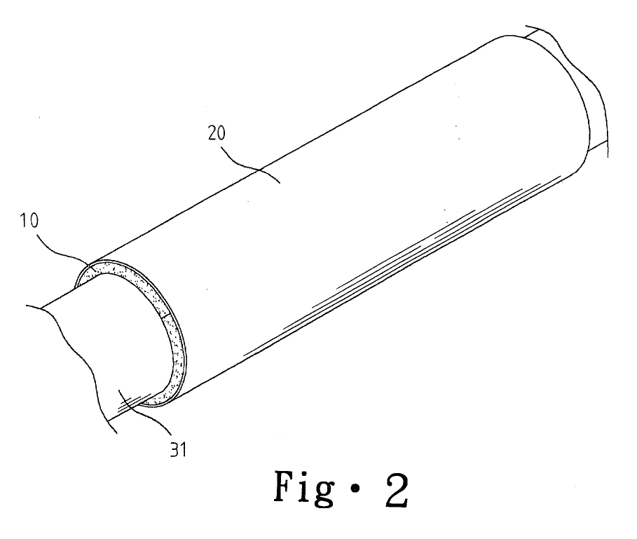

FIG. 3: shows a 3D exploded view of the present invention.

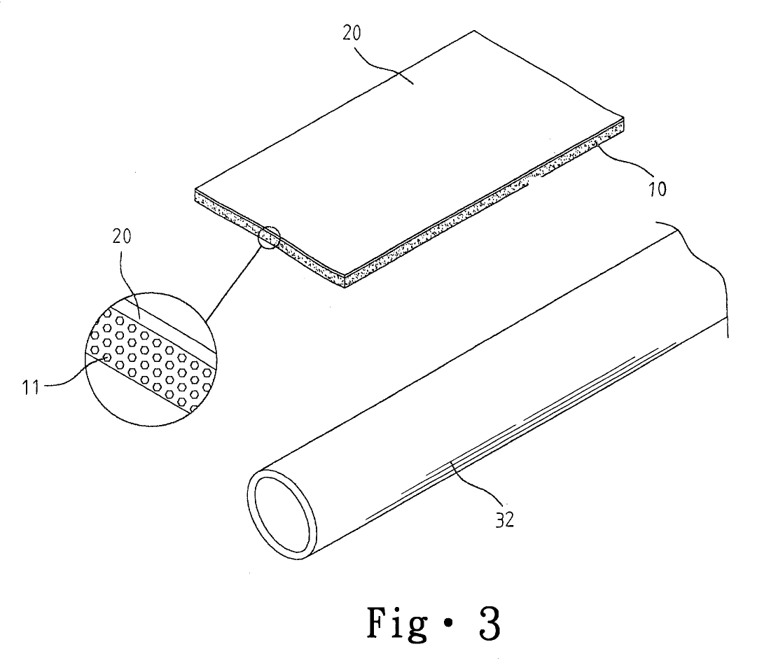

FIG. 4: shows another 3D exploded view of the present invention.

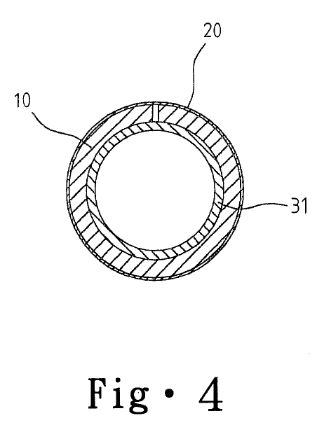

FIG. 5: shows another combined schematic view of the present invention.

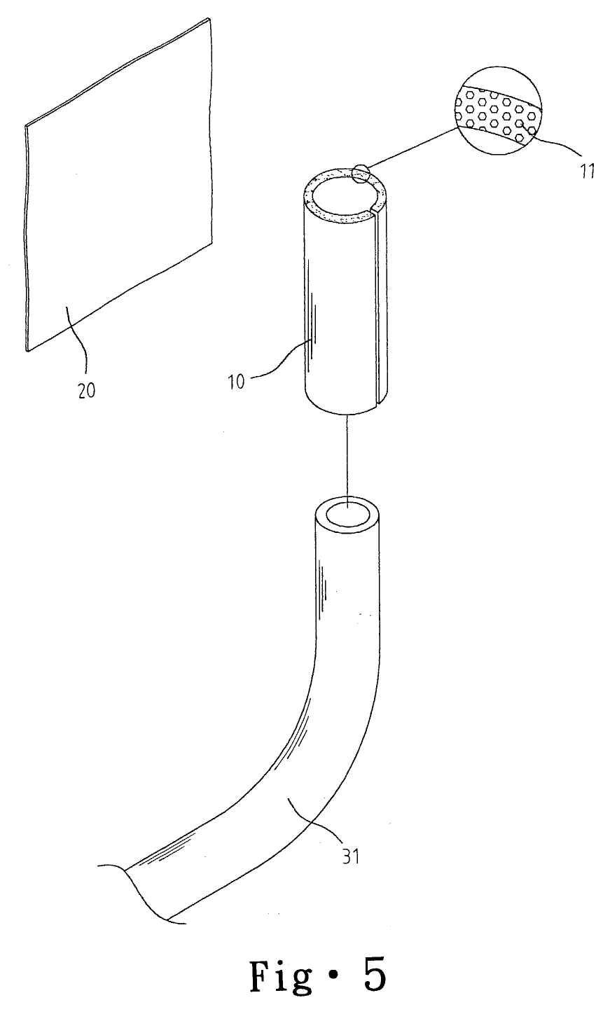

FIG. 6: shows a combined perspective view of the present invention.

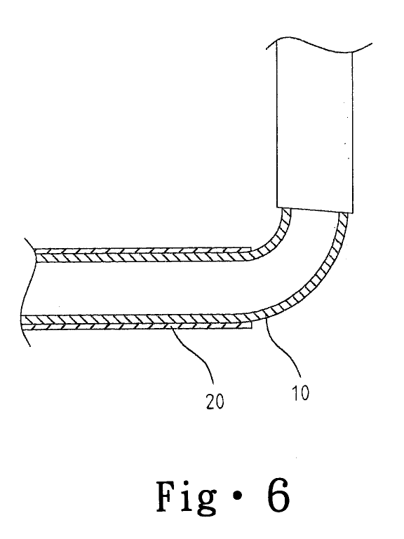

FIG. 7: shows a molecule schematic view of the rearrangement of gas molecule and air molecule.

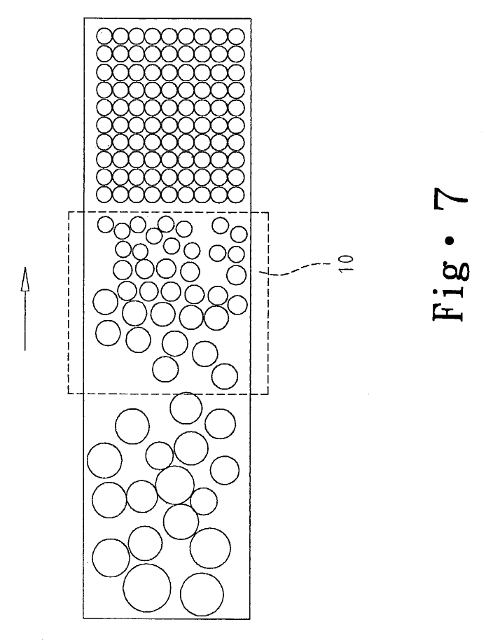

FIG. 8: shows a process of the rearrangement of gas molecule and air molecule.

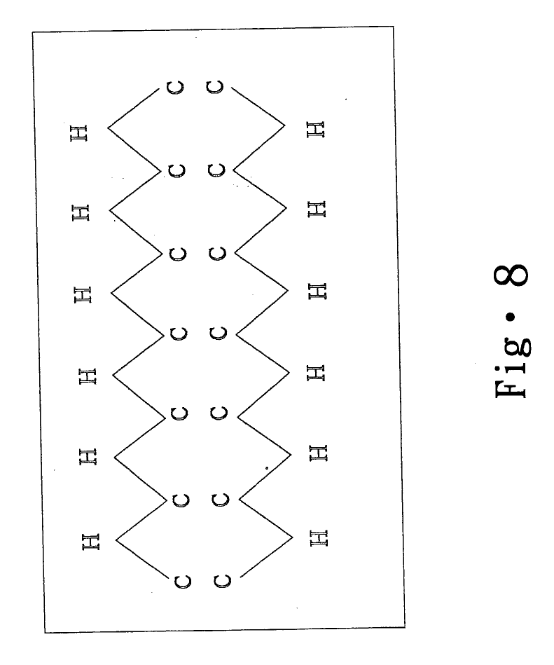

FIG. 9: shows a perspective plan view of the practical example of the present invention.

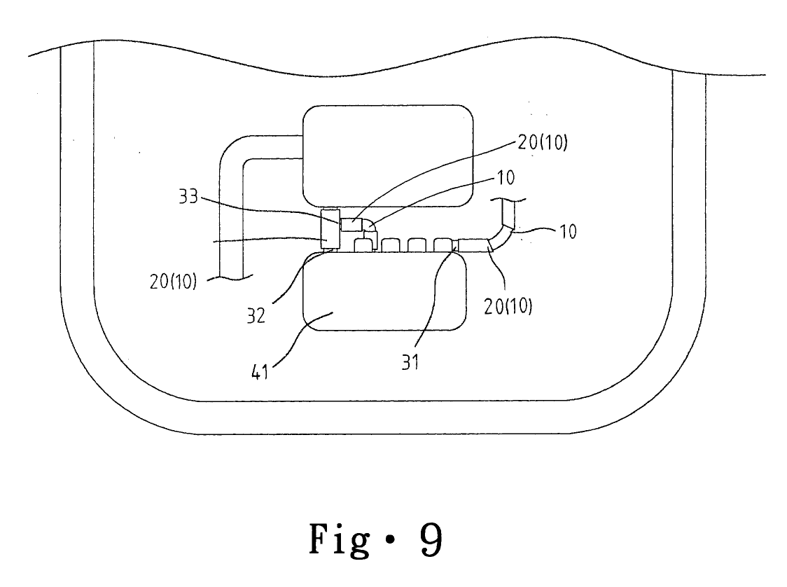

### DESCRIPTION OF DRAWINGS

rubber vesicant: 10 valve: 11

led metal sheet (or led type metal sheet): 20

fuel pipe line: 31

intake pipe: 32 exhaust gas circling pipe: 33

engine: 41

What is claimed is:

1. “The Structure of Fuel Complete Combustion Acceleration for Automotive Vehicles” relates generally to the outer part of the fuel pipe, intake pipe and exhaust gas circling pipe of automobiles or motorcycles and wrapped up with a rubber vesicant, which mixed the rubber and metal oxide material which contains infrared ray and formed in proper ratios so that the rubber vesicant has electromagnetic radial function of far infrared ray which can then make the gas molecule and air molecule of those three pipes rearranged in order so as to accelerate the gas complete combustion and achieve the purpose of gas saving, decrease exhaust gas pollution. And the outer part of the rubber vesicant can be covered with one led metal sheet or more (or led type metal sheet) not only to fix the rubber vesicant, but also to absorb heat fast and to cover, separate, decrease the energy coming from the electromagnetic wave of the far infrared ray outward so as to gather up the energy in those 3 pipes.

2. “The Structure of Fuel Complete Combustion Acceleration for Automotive Vehicles” relates generally to the outer part of the fuel pipe, intake pipe and exhaust gas circling pipe of automobiles or motorcycles and wrapped up with a rubber vesicant, which is formed in a proper ratios by mixing up with the rubber and metal oxide materials that contains far infrared ray. In this way, the rubber vesicant has radial function of electromagnetic wave of the far infrared ray, which can rearrange the gas molecule and air molecule within the three pipes in order so as to accelerate the fuel to a complete combustion and achieve the purpose of gas saving, decreasing exhaust gas.

3. “The Structure of Fuel Complete Combustion Acceleration for Automotive Vehicles” focuses on its being used on the fuel pipe, intake pipe and waste gas exhaust circling pipe of automobiles and motorcycles and installed with a cover which has function of covering, which has metal oxide material that has radial function of electromagnetic wave of the far infrared ray. Therefore, it can rearrange the gas molecule and air molecule within the three pipes in order so as to accelerate the fuel to a complete combustion. Meanwhile, to ensure the electromagnetic wave of the far infrared ray, the outer part of the cover is wrapped up with one led metal sheet (or led type metal sheet) or more, which can not only to fix the cover but also speed up the heat absorbing, cover and separate to decrease the electromagnetic wave of the far infrared ray spread outward as well as to concentrate them within the three pipes.
